(19) United States
(12) Patent Application Publication
(10) Pub. No.: US 2008/0278593 A1
(43) Pub. Date: Nov. 13, 2008

(54) Camera Apparatus

(75) Inventors: Hideo Cho, Kanagawa (JP); Yuichi Asami, Kanagawa (JP); Takahiko Masu, Kanagawa (JP); Satoshi Uchikura, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/569,770

(22) PCT Filed: Jun. 2, 2005
(86) PCT No.: PCT/JP2005/010147

§ 371 Date: Feb. 6, 2007

(30) Foreign Application Priority Data
Jun. 3, 2004 (JP) 2004-165989

(51) Int. Cl. H04N 5/228

(52) U.S. Cl. 348/222.1; 348/E05.031

(57) ABSTRACT

It is an object of the present invention to provide a camera apparatus that can keep the aperture within an appropriate range, and keep, within a designated range, the luminance of images to be taken over a long period of time. The camera apparatus comprises image providing means 11 for providing images corresponding to three primary colors in light by having light coming from an object passed therethrough, converting means 12 for converting the images into R-, G-, and B-image signals, continuous-change-in-amount-of-light means 13 for attaining continuous change in amount of light to be received by the converting means 12 through the image providing means 11, stepwise-change-in-amount-of-light means 14 for attaining stepwise change in amount of light to be received by the converting means 12 through the image providing means 11, gain adjusting means 15 for adjusting gains corresponding to the R-, G-, and B-image signals, and regulating the R-, G-, and B-image signals on the basis of the adjusted gains, luminance controlling means 16 for performing, in response to a luminance value calculated from the regulated R-, G-, and B-image signals, a control of a luminance of an image, and image signal outputting means 17 for outputting the regulated R-, G-, and B-image signals, wherein the luminance controlling means 16 includes a luminance deviation calculating unit for calculating a luminance difference between a predetermined reference value and the calculated luminance value, an amount-of-continuous-change judging unit for judging whether or not an amount of continuous change attained by the continuous-change-in-amount-of-light means 13 is in a predetermined range, a continuous control unit for controlling, on the basis of the luminance deviation, the continuous-change-in-amount-of-light means 13 when the amount of continuous change is in the predetermined range, and a stepwise control unit for controlling, on the basis of the luminance deviation, the stepwise-change-in-amount-of-light means 14 when the amount of continuous change is not in the predetermined range.

### TECHNICAL FIELD OF THE INVENTION

This invention relates to a camera apparatus, and more particularly to a camera apparatus for controlling an aperture diaphragm to keep its aperture within an appropriate range even if the amount of light to be received from an object is fluctuated widely, and maintaining, at a designated level, the luminance of images to be taken over a long period of time.

### DESCRIPTION OF THE RELATED ART

In general, it is important, for a camera apparatus such as a surveillance camera for keeping on taking images over a long period of time, to take images at a relatively high clarity with being affected by variations in luminance of an object.

As one of conventional camera apparatuses, there has been known a camera apparatus that is disclosed in Jpn. unexamined patent publication No. S57-153380 (p 2, upper right column, lines 5 to 19, and FIG. 2), and adapted to keep luminance of images within an appropriate range in response to an image signal by automatically controlling an aperture diaphragm to keep its aperture within an appropriate range.

The conventional camera apparatus, however, has a narrower tolerance to change in luminance of the object.

When the luminance of the object is changed within a relatively wide range, a filter is appropriately selected and attached to the camera apparatus by a user.

In the conventional camera apparatus constituted as surveillance camera for watching a current weather, and taking images over a long period of time at a relatively high clarity, its filter is manually changed by a user in the daytime and in the nighttime. When the filter is not appropriately changed by the user, the conventional camera apparatus cannot maintain the quality of images to be taken over a long period of time.

### DISCLOSURE OF THE INVENTION

### Problems To Be Solved By the Invention

It is, therefore, an object of the present invention to provide a camera apparatus that can keep the aperture within an appropriate range, and keep, within a designated range, the luminance of images to be taken over a long period of time.

### Means For Solving the Problems

According to the first invention, there is provided a camera apparatus, comprising: image providing means for providing images corresponding to three primary colors in light; converting means for converting the images into R-, G-, and B-image signals; continuous-change-in-amount-of-light means for attaining continuous change in amount of light to be received by the converting means through the image providing means; stepwise-change-in-amount-of-light means for attaining stepwise change in amount of light to be received by the converting means through the image providing means; gain adjusting means for adjusting gains corresponding to the R-, G-, and B-image signals, and regulating the R-, G-, and B-image signals on the basis of the adjusted gains; luminance controlling means for controlling luminance of image in response to a luminance value calculated from the regulated R-, G-, and B-image signals; and image signal outputting means for outputting the regulated R-, G-, and B-image signals, wherein the luminance controlling means includes: a luminance deviation calculating unit for calculating a luminance deviation between a reference value and the calculated luminance value; an amount-of-continuous-change judging unit for judging whether or not an amount of continuous change attained by the continuous-change-in-amount-of-light means is in a predetermined range; a continuous control unit for controlling, on the basis of the luminance deviation, the continuous-change-in-amount-of-light means when the amount of continuous change is in the predetermined range; and a stepwise control unit for controlling, on the basis of the luminance deviation, either or both of the gain adjusting means and the stepwise-change-in-amount-of-light means when the amount of continuous change is not in the predetermined range.

The camera apparatus thus constructed according to the first invention can keep, in the predetermined range, the amount of continuous change to be attained by the stepwise-change-in-amount-of-light means by controlling the gain adjusting means or the stepwise-change-in-amount-of-light means, and keep the luminance of images at the predetermined luminance.

In the camera apparatus according to the second invention, the amount-of-continuous-change judging unit is adapted to execute a hysteresis routine to enlarge the predetermined range when at least one of the gain adjusting means, the continuous-change-in-amount-of-light means, and the stepwise-change-in-amount-of-light means is activated.

The camera apparatus thus constructed according to the second invention can prevent a repetitive operation of the gain adjusting means or the stepwise-change-in-amount-of-light means.

In the camera apparatus according to the third invention, the luminance deviation calculating unit is adapted to calculate an averaged luminance deviation by integrating the luminance deviation over a first period of time.

The camera apparatus thus constructed according to the third invention can designate a speed to ensure that the luminance is updated at a designated speed.

The camera apparatus according to the present invention further comprises luminance limitation means for setting, as the luminance value, a predetermined upper limit when the luminance of the image exceeds the upper limit.

The camera apparatus thus constructed according to the present invention can prevent the images to be taken over a long period of time from being excessively decreased in luminance.

In the camera apparatus according to the present invention, the luminance controlling means is adapted to assume a standby mode to stop the control of the luminance of the image when the luminance of the image meets a predetermined requirement.

The camera apparatus thus constructed according to the present invention can keep, at a designated level, the luminance of images to be taken over a long period of time.

In the camera apparatus according to the present invention, the luminance controlling means is adapted to restart the control of the luminance of the image after stopping the control of the luminance of the image over a second period of time when the luminance of the image meets a predetermined requirement.

The camera apparatus thus constructed according to the present invention can keep, within a designated range, the luminance of images to be taken over a long period of time.

### Advantageous Effect of the Invention

It is an object to provide a camera apparatus having an advantageous effect of keeping the aperture within an appropriate range, and keeping the luminance of images within a designated range even if the luminance of the object is excessively fluctuating.

### BRIEF DESCRIPTION OF THE DRAWINGS

The present invention and many of the advantages thereof will be better understood from the following detailed description when considered in connection with accompanying drawings, wherein:

FIG. 1 is a functional block diagram showing the camera apparatus according to the present invention;

FIG. 2 is a detailed block diagram showing the camera apparatus according to the present invention;

FIG. 3 is a flowchart for explaining the first main routine to be executed by the camera apparatus according to the first embodiment of the present invention;

FIG. 4 is a flowchart for explaining the first luminance deviation calculating routine to be executed by the camera apparatus according to the first embodiment of the present invention;

FIG. 5 is a flowchart for explaining the amount-of-light reducing routine to be executed by the camera apparatus according to the first embodiment of the present invention;

FIG. 6 is a flowchart for explaining the amount-of-light increasing routine to be executed by the camera apparatus according to the first embodiment of the present invention;

FIG. 7 is a flowchart for explaining the aperture control routine to be executed by the camera apparatus according to the first embodiment of the present invention;

FIG. 8 is a flowchart for explaining the neutral density filter control routine to be executed by the camera apparatus according to the first embodiment of the present invention;

FIG. 9 is a flowchart for explaining the gain control routine to be executed by the camera apparatus according to the first embodiment of the present invention;

FIG. 10 is a flowchart for explaining the second main routine to be executed by the camera apparatus according to the second embodiment of the present invention;

FIG. 11 is a flowchart for explaining the hysteresis routine to be executed by the camera apparatus according to the second embodiment of the present invention;

FIG. 12 is a flowchart for explaining the second luminance deviation calculating routine to be executed by the camera apparatus according to the third embodiment of the present invention;

FIG. 13 is a flowchart for explaining the third luminance deviation calculating routine to be executed by the camera apparatus according to the fourth embodiment of the present invention;

FIG. 14 is a flowchart for explaining the third main routine to be executed by the camera apparatus according to the fifth embodiment of the present invention; and

FIG. 15 is a flowchart for explaining the fourth main routine to be executed by the camera apparatus according to the sixth embodiment of the present invention.

### EXPLANATION OF THE REFERENCE NUMERALS

1: camera apparatus
11: image providing means
12: converting means
13: continuous-change-in-amount-of-light means
14: stepwise-change-in-amount-of-light means
15: gain adjusting means
16: luminance controlling means
17: image signal outputting means
111: lens unit
112: CC filter
121: dichroic prism
122: R-CCD
123: G-CCD
124: B-CCD
131: aperture diaphragm
141: ND filter
151: R-preamplifier
152: G-preamplifier
153: B-preamplifier
154: R-gain controller
155: G-gain controller
156: B-gain controller
161: aperture controller
162: ND filter controller
181: R-level controller
182: B-level controller
183: CC filter
2: microprocessor
21: CPU
22: memory unit
23: buffer unit
24: interface unit
25: bus line
3: A/D converter

### DESCRIPTION OF THE PREFERRED EMBODIMENTS

The first to sixth embodiments of the camera apparatus according to the present invention will be described hereinafter with reference to accompanying drawings.

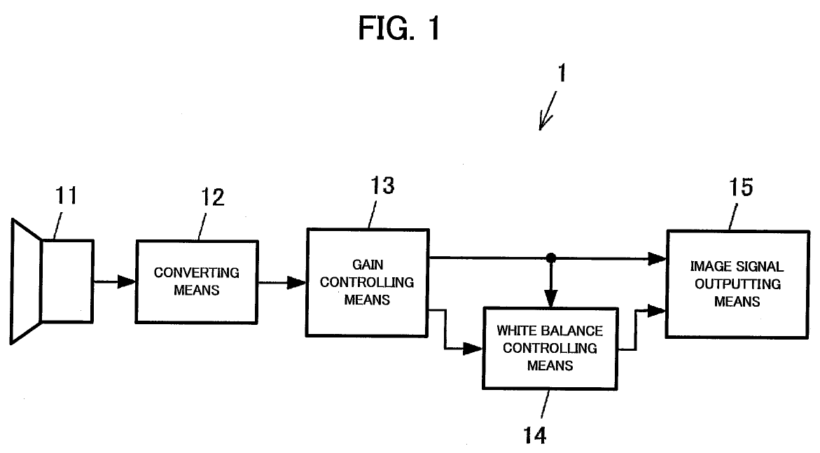

As shown in FIG. 1, the camera apparatus 1 according to the present invention comprises image providing means 11 for providing R-, G-, and B-images corresponding to three primary colors in light, converting means 12 for converting the R-, G-, and B-images into R-, G-, and B-image signals, continuous-change-in-amount-of-light means 13 for ensuring a continuous change in amount of light to be received by the converting means 12 through the image providing means 11, stepwise-change-in-amount-of-light means 14 for ensuring s stepwise change in amount of light to be received by the converting means 12 through the image providing means 11, gain adjusting means 15 for adjusting gains corresponding to the R-, G-, and B-image signals, and regulating the R-, G-, and B-image signals on the basis of the adjusted gains, luminance controlling means 16 for controlling, in luminance, the image on the basis of a luminance value “Y” calculated from the regulated R-, G-, and B-image signals, and image signal outputting means 17 for outputting the regulated R-, G-, and B-image signals.

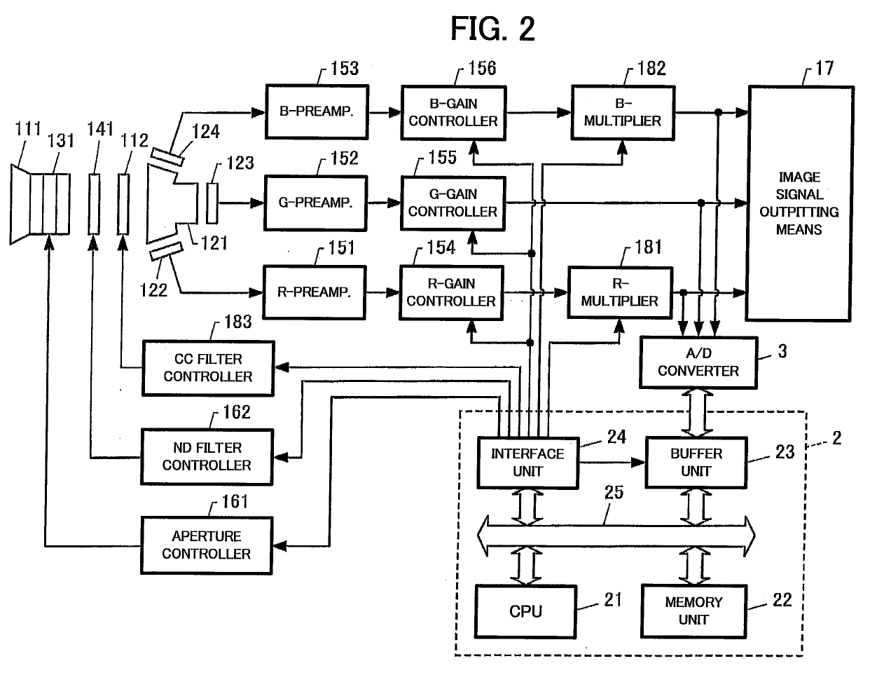

FIG. 2 is a detailed block diagram showing the camera apparatus 1 according to the present invention. As shown in FIG. 2, the image providing means 11 includes a lens unit 111 having a light (coming from an object) transmitted therethrough, and a chromatic compensation filter (CC filter) 112 for performing, on the basis of a color temperature of an illumination lamp or the like, a chromatic compensation to the light transmitted through the lens unit 111.

The converting means 12 includes a dichroic prism 112 for splitting the light into R-, G-, and B-components corresponding to the primary colors in light, and charge-coupled devices 122 to 124 corresponding to the primary colors in light (R-, G-, and B-CCDs). the R-, G-, and B-CCDs 122 to 124 are adapted to convert the R-, G-, and B-images into R-, G-, and B-image signals.

The continuous-change-in-amount-of-light means 13 is constituted by an aperture diaphragm 131 for attaining a continuous change in amount of light to be received by the converting means 12 through the image providing means 11, while the stepwise-change-in-amount-of-light means 14 is constituted by neutral density filters (ND filter) 141 for attaining stepwise change in amount of light to be received by the converting means 12 through the image providing means 11. The ND filter 141 includes a filter board having filters mounted thereon, the filters including a plain filter, and a plurality of filter plates capable of being disposed on a light path, and different in light transmission from one another (the filters may include, for example, three filters having light transmissions of 25 [%], 6.3 [%], and 3.2 [%]).

The gain adjusting means 15 includes R-, G-, and B-preamplifiers 151 to 153 for regulating the R-, G-, and B-image signals outputted by the R-, G-, and B-CCDs 122 to 124, and R-, G-, and B-gain controllers 154 to 156 for adjusting gains of the R-, G-, and B-preamplifiers 151 to 153 on the basis of the R-, G-, and B-image signals amplified by the R-, G-, and B-preamplifiers 151 to 153. P The luminance controlling means 16 includes a microprocessor 2 for producing gain control signals for the R-, G-, and B-gain controllers 154 to 156, an aperture control signal for the aperture diaphragm 131, and a neutral density control signal (ND control signal) for the ND filter 141 in response to the regulated R-, G-, and B-image signals, an analog-to-digital converter (A/D converter) 3 for converting the regulated R-, G-, and B-image signals into digital signals, an aperture controller 161 for controlling the aperture diaphragm 131 in response to the aperture control signal produced by the microprocessor 2, and a neutral density controller (ND filter controller) 162 for controlling the filter board in response to the ND control signal produced by the microprocessor 2.

Additionally, the camera apparatus 1 may further comprises, as a real device, R- and B-level controllers 181 and 182 corresponding to the primary color in light “R” and “B”, and a chromatic compensation filter controller (CC filter controller) 183 for controlling the CC filter 112 in response to a chromatic compensation control signal (CC control signal) received from the microprocessor 2. The R- and B-level controllers 181 are adapted to correct a white balance by adjusting, in level, either or both the R- and B-image signals.

The microprocessor 2 has a memory unit 22 having a program stored therein, a central processing unit (CPU) 21 for executing the program, a buffer unit 23 having the digital signals (converted from the R-, G-, and B-image signals by the A/D converter 3) stored therein, and an interface unit 24 for outputting the gain control signals, the aperture control signal, and the ND filter control signal produced by the CPU 21. The CPU 21, the memory unit 22, the buffer unit 23, and the interface unit 24 are electrically connected to one another through a bus line 25.

Additionally, the interface unit 24 is adapted to output R- and B-control signals for the R- and B-multipliers 181 and 182, and a filter control signal for the CC filter 112.

The following description will be directed to the operations of the camera apparatus according to the first to sixth embodiments of the present invention. Each embodiment of the camera apparatus according to the present invention is characterized by the program installed into the memory unit 22.

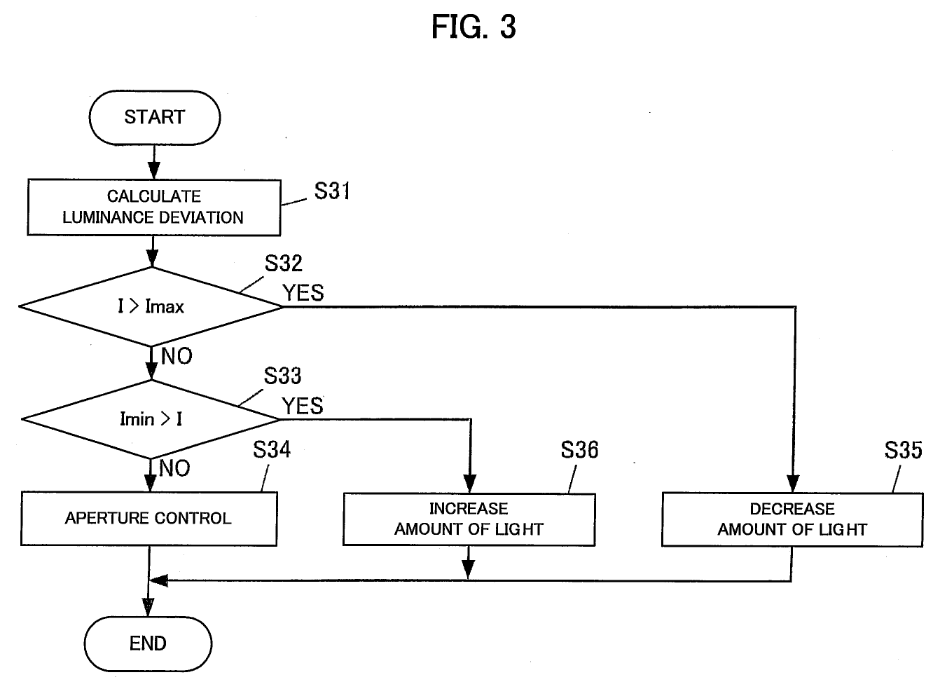

The operation of the camera apparatus according to the first embodiment of the present invention will be firstly described hereinafter with reference to the first main routine shown by the flowchart of FIG. 3.

The CPU 21 calculates a luminance deviation “A d” from a reference luminance “Yd” to the luminance value “Y” (of the regulated R-, G-, and B-image signals) (in the step S31).

The judgment is then made by the CPU 21 (in the step S32) on whether or not a current aperture value “I” of the aperture diaphragm 131 exceeds a predetermined maximum value “Imax”.

When the judgment is made that the current aperture value “I” does not exceed the maximum value “Imax”, the judgment is made by the CPU 21 (in the step S33) on whether or not the current aperture value “I” is smaller than a predetermined minimum value “Imin”.

When the judgment is made that the current aperture value “I” is not smaller than the minimum value “Imin”, the CPU 21 allows the aperture controller 161 to control the aperture diaphragm 131 (in the step S34) to ensure that the aperture diaphragm 131 has an aperture adjusted appropriately in size, and completes this routine.

When the judgment is made that the current aperture value “I” is larger than the predetermined maximum value “Imax”, the CPU 21 maintains a resolving power by executing an amount-of-light reducing routine (which will be described hereinafter in detail) to have the filter controller 162 control the ND filter 141, or to have the R-, G-, and B-gain controllers 154 to 156 adjust the gains (in the step S35), and completes this routine.

When the current aperture value “I” is smaller than the predetermined minimum value “Imin”, the CPU 21 suppresses a color aberration by executing an amount-of-light increasing routine (which will be described hereinafter in detail) to have the filter controller 162 control the ND filter 141, or to have the R-, G-, and B-gain controllers 154 to 156 adjust the gains (in the step S36), and completes this routine.

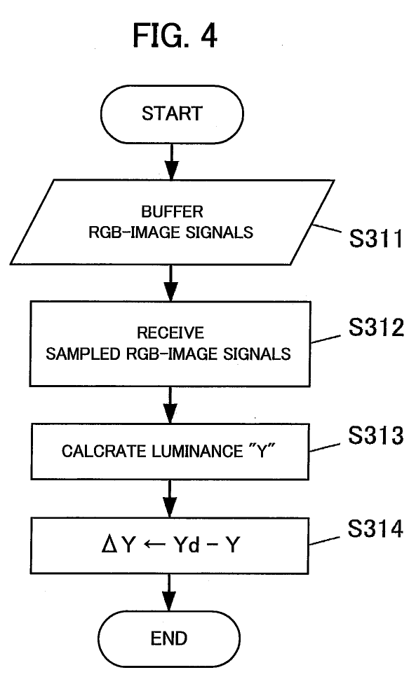

FIG. 4 is a flowchart showing the first luminance deviation calculating routine to be executed (in the step S31) of the first main routine shown by the flowchart of FIG. 3. As shown in FIG. 4, the regulated RGB-image signal are received and buffered by the CPU 21 through the A/D converter 3 (in the step S311).

The CPU 21 executes a sampling routine to take an image sample from the regulated R-, G-, and B-image signals (in the step S312). More specifically, the CPU 21 takes image samples appropriate for a luminance regulation from the regulated R-, G-, and B-image signals by issuing an instruction to the buffer unit 23 to output R-, G-, and B-image signals corresponding to a central portion which accounts for, for example, 25 [%], 50 [%], or 90 [%] of each image.

The CPU 21 calculates a luminance value “Y” of the image from the image samples (in the step S313), calculates a luminance deviation “Δ d” from a reference luminance Yd to the luminance value “Y” of the image (in the step S314), and completes this routine.

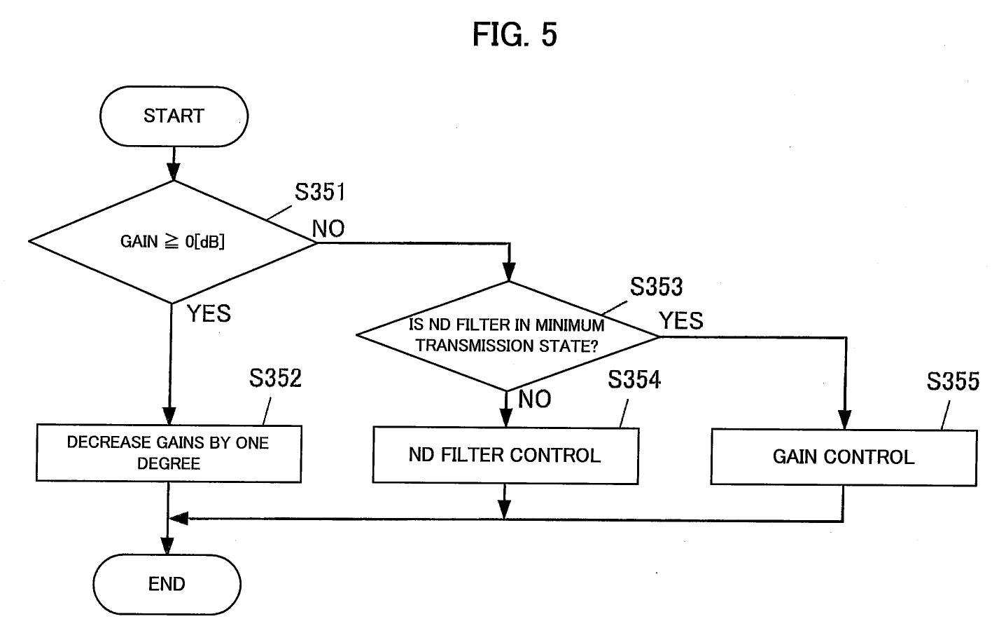

FIG. 5 is a flowchart showing an amount-of-light reducing routine to be executed by the CPU 21 (in the step 35) of the first main routine shown by the flowchart of FIG. 3. As shown in FIG. 5, the judgment is made by the CPU 21 (in the step S351) on whether or not the gains to be adjusted by the R-, G-, and B-gain controllers 154 to 156 exceeds zero [dB].

When the gains exceeds zero [dB], the CPU 21 reduces the gains by a specific value (in the step S352), and completes this routine. When, on the other hand, the gains does not exceed zero [dB], the judgment is made by the CPU 21 (in the step S353) on whether or not the amount “F” of light transmitted through the selected filter plate of the ND filter 141 is smaller than a minimum level Fmin defined as a valid criterion in judging whether or not the luminance value “Y” of the image to be provided by the image providing means 11 is too small to be adjusted by the ND filter 141.

When the amount “F” of light transmitted through the selected filter plate of the ND filter 141 is not smaller than the minimum level “Fmin”, the CPU 21 makes a decision that the luminance of the image to be provided by the image providing means 11 can be controlled by the ND filter 141, keeps controlling the ND filter 141 (in the step S631), and completes this routine.

When, on the other hand, the amount “F” of light transmitted through the selected filter plate of the ND filter 141 is smaller than the minimum level “Fmin”, the CPU 21 makes a decision that the luminance of the image to be provided by the image providing means 11 cannot be controlled by the ND filter 141, starts to control the gains without controlling the ND filter 141, and completes this routine.

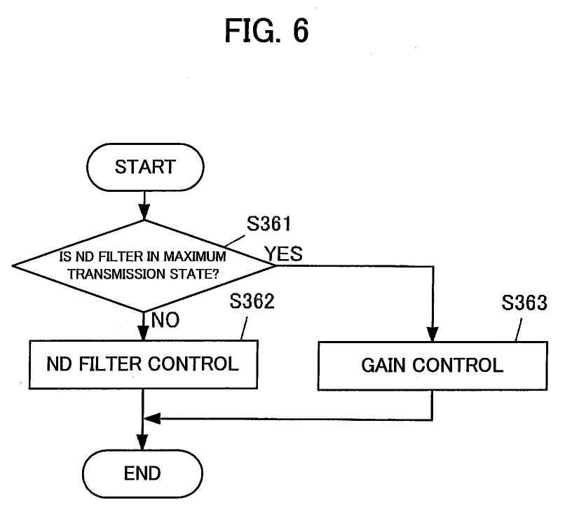

FIG. 6 is a flowchart showing the amount-of-light increasing routine to be executed by the CPU 21 (in the step 36) of the first main routine shown by the flowchart of FIG. 3. As shown in FIG. 6, the judgment is made by the CPU 21 (in the step S361) on whether or not the amount “F” of light transmitted through the selected filter plate of the ND filter 141 is larger than a maximum level “Fmax” previously defined as a valid criterion in judging whether or not the luminance value of the image provided by the image providing means 11 exceeds an adjustable range of the ND filter 141.

When the amount “F” of light transmitted through the selected filter plate of the ND filter 141 is smaller than or equal to the maximum level “Fmax”, the CPU 21 makes a decision that the luminance of the image provided by the image providing means 11 can be controlled by the ND filter 141, keeps controlling the ND filter 141 (in the step S362), and completes this routine.

When, on the other hand, the amount “F” of light transmitted through the selected filter plat of the ND filter 141 is larger than the maximum level “Fmax”, the CPU 21 makes a decision that the luminance of the image provided by the image providing means 11 cannot be controlled by the ND filter 141, starts to control the gains without controlling the ND filter 141 (in the step S363), and completes this routine.

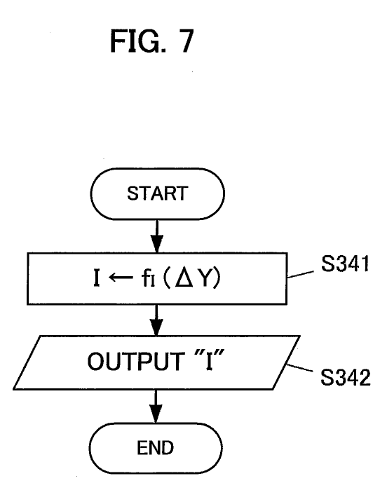

FIG. 7 is a flowchart showing an aperture control routine to be executed by the CPU 34 (in the step 34) of the first main routine shown by the flowchart of FIG. 3. As shown in FIG. 7, the CPU 21 updates an aperture value “I” as a function of the luminance deviation “Δ Y” (in the step S341), and outputs the currently-updated aperture value “I” (in the step S342).

The CPU 21 outputs the currently-updated aperture value to the aperture controller 161 through the interface unit 24 (in the step S341), and has the aperture controller 161 control the aperture diaphragm 131 on the basis of the currently-updated aperture value.

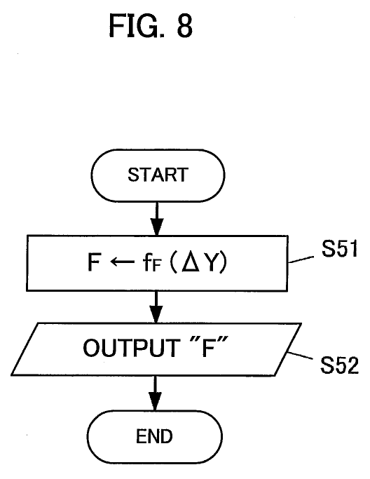

FIG. 8 is a flowchart showing a neutral density filter control routine to be executed (in the step S354) of the amount-of-light increasing routine shown by the flowchart of FIG. 5, and (in the step S362) of the amount-of-light reducing routine shown by the flowchart of FIG. 6. As shown in FIG. 8, the CPU 21 decides the amount “F” of light to be transmitted through newly-selected filter plate of the ND filter 141 by using a function of the luminance deviation “Δ Y” (in the step S51), and produces information on the amount “F” of light to be transmitted through the newly-selected filter plate of the ND filter 141 (in the step S52).

The CPU 21 outputs the information to the ND filter controller 162 through the interface unit 24, has the ND filter controller 162 select one of the filter plates of the ND filter 141 on the basis of received information, and locates the newly-selected filter plate of the ND filter 141 on an optical path, and between the lens unit 111 and the dichroic prism 121.

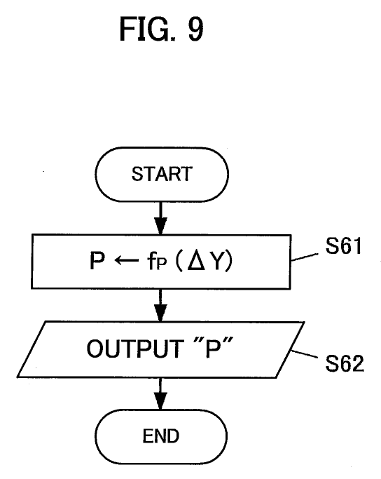

FIG. 9 is a flowchart showing a gain control routine to be executed in the step S355 of the amount-of-light increasing routine shown by the flowchart of FIG. 5, and in the step S363 of the amount-of-light reducing routine shown by the flowchart of FIG. 6. As shown in FIG. 9, the CPU 21 decides latest gains “P” by using a function of the luminance deviation “Δ Y” (in the step S61), and outputs the latest gains “P” (in the step S62).

The CPU 21 outputs the latest gains “P” to the R-, G-, and B-gain controllers 154 to 156 through the interface unit 24 to set the latest gains “P” to the R-, G-, and B-gain controllers 154 to 156.

When the current aperture value of the aperture diaphragm is not within an appropriate range, the camera apparatus according to the first embodiment has a priority to control the ND filter. However, the camera apparatus according to the first embodiment may have a priority of controlling the gains “P” over controlling the ND filter.

From the foregoing description, it will be understood that the camera apparatus according to the first embodiment of the present invention can keep the aperture value within an appropriate range, and maintain the luminance of the image at a designated level by comprising luminance controlling means for controlling the ND filter or the gains.

The operation of the camera apparatus according to the second embodiment of the present invention will be then described hereinafter.

When the gains are adjusted at intervals by the R-, G-, and B-gain controllers 154, 155, and 156, and when the R-, G-, and B-image signals are controlled in luminance with the adjusted gains, the R-, G-, and B-gain controllers 154, 155, and 156 tend to adjust gains with frequency, and the ND filter controller 162 tends to select the ND filter 141 with frequency.

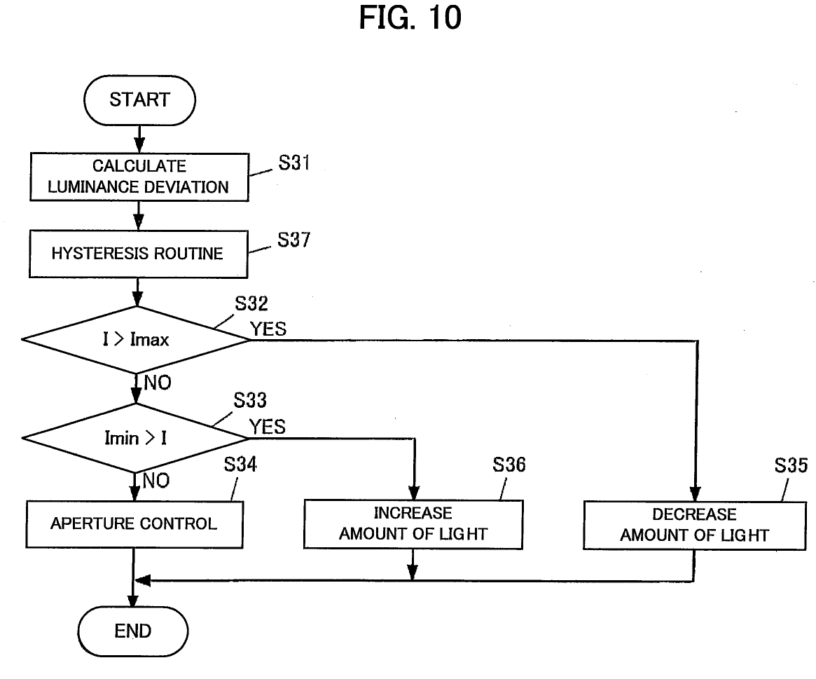

FIG. 10 is a flowchart showing the second main routine to be executed by the CPU 21 of the camera apparatus according to the second embodiment of the present invention. As shown in FIG. 10, the second main routine is substantially the same as the first main routine with the exception that the second main routine includes a hysteresis routine to be executed in the step S37 defined between the steps S31 and S32 in order to reduce excessively repetitive operations of the ND filter 141 and the R-, G-, and B-gain controllers 154, 155, and 156.

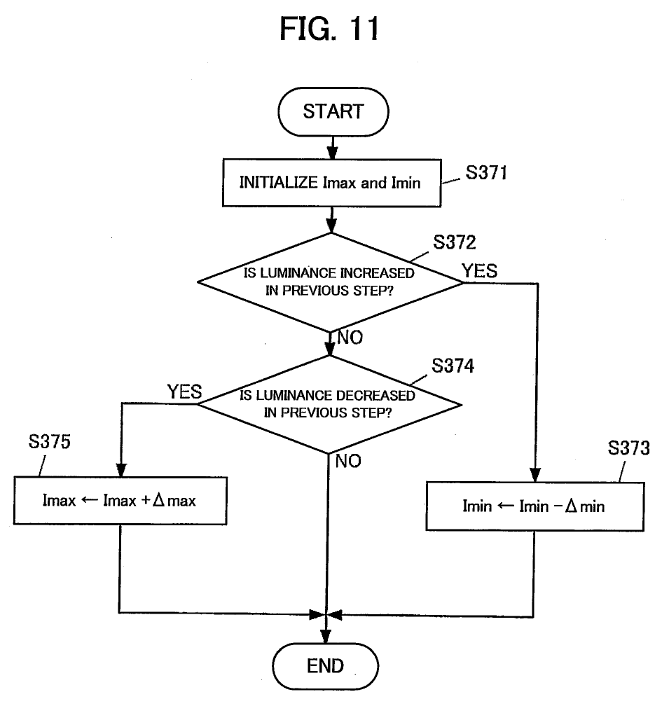

FIG. 11 is a flowchart showing a hysteresis routine to be executed by the CPU 21. As shown in FIG. 11, the maximum and minimum aperture values “Imax” and “Imin” are firstly reset to initial values by the CPU 21 (in the step S371).

The judgment is then made by the CPU 21 (in the step S372) on whether or not the luminance of images is increased in last luminance controlling step. When the luminance of images is increased in the last luminance controlling step, the CPU 21 enlarges the difference between the maximum and minimum aperture values “Imax” and “Imin” by reducing the minimum aperture value “Imin” by a predetermined value “Δmin” (in the step S373), and completes this routine.

When, on the other hand, the luminance of images is not increased in the last luminance controlling step, the judgment is then made by the CPU 21 (in the step S374) on whether or not the luminance of images is decreased in last luminance controlling step. When the luminance of images is decreased in the last luminance controlling step, the CPU 21 enlarges the difference between the maximum and minimum aperture values “Imax” and “Imin” by increasing the maximum aperture value “Imax” by a predetermined value “Δ max” (in the step S375), and completes this routine. When, on the other hand, the luminance of images is not decreased in the last luminance controlling step, the CPU 21 completes this routine without adjusting the difference between the maximum and minimum aperture values “Imax” and “Imin”.

The routines of the camera apparatus according to the second embodiment are substantially the same in construction as the camera apparatus according to the first embodiment with the exception of the above-mentioned routines. Therefore, the elements of the camera apparatus according to the second embodiment the same as those of the camera apparatus according to the first embodiment will not be described hereinafter.

From the foregoing description, it will be understood that the camera apparatus according to the second embodiment of the present invention can prevent the ND filters 141 from being repeatedly switched by the ND filter controller, or prevent the gains from being repeatedly changed by the gain controllers 154, 155, and 156 by allowing the CPU 21 to execute the hysteresis routine.

The following description will be directed to the operation of the camera apparatus according to the third embodiment of the present invention.

When the camera apparatus according to the present invention calculates a luminance deviation in each field, the camera apparatus according to the present invention is required to avoid an excessive repetition of the same routine.

When, on the other hand, an object is being rapidly varied in luminance, the camera apparatus according to the present invention is required to control, in luminance, images to be taken over a long period of time by calculating, with a relatively short period of time, the luminance deviation “Δ Y”.

It is preferable that the luminance deviation “Δ Y” calculated in each field period of time is averaged in a settable period of time.

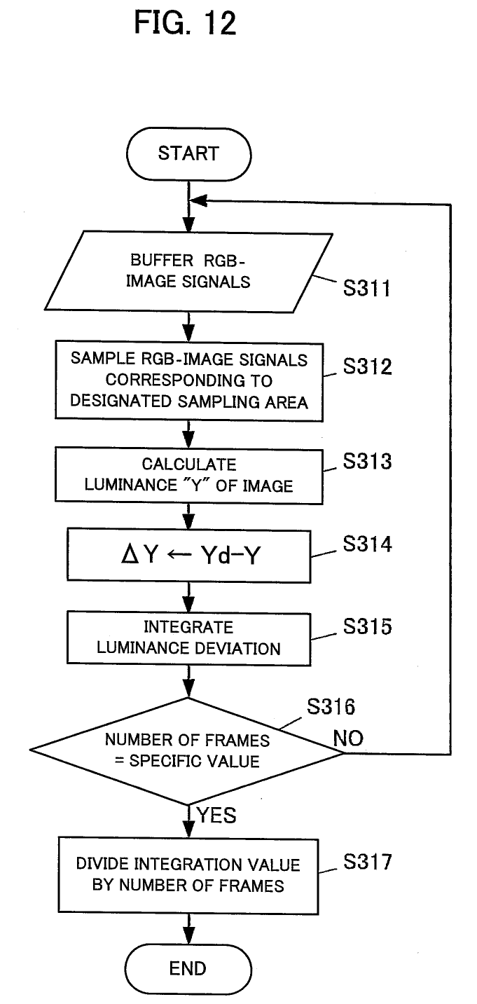

FIG. 12 is a flowchart showing a second luminance deviation calculating routine to be executed by the CPU 21 of the camera apparatus according to the fifth embodiment of the present invention. As shown in FIG. 12, the second luminance deviation calculating routine is substantially the same as the first luminance deviation calculating routine with the exception that the second luminance deviation calculating routine includes a routine to be executed in the steps S318 and S319 defined between the steps 313 and 314.

The luminance deviation “Δ Y” is calculated (in the step S314), and integrated (in the step S315) by the CPU 21.

The judgment is made (in the step S316) by the CPU 21 on whether or not the regulated R-, G-, and B-image signals are buffered over a period of time (i.e. designated frames). When the number of frames of the buffered R-, G-, and B-image signals is smaller than the number of the designated frames, the CPU 21 continues to buffer the regulated R-, G-, and B-image signals (in the step S311).

When, on the other hand, the number of frames of the buffered R-, G-, and B-image signals is equal to the number of the designated frames, the CPU 21 stops integrating the luminance deviation “Δ Y”. Then, the CPU 21 divides its integration value by the number of the designated frames (in the step S317), and completes this routine.

When the CPU 21 executes the second luminance deviation calculating routine, the CPU 21 can reduce, by increasing the number of designated frames, a control speed at which the luminance of images is controlled, and can increase the control speed by decreasing the number of designated frames.

The routines of the camera apparatus according to the third embodiment are substantially the same as those of the camera apparatus according to the first embodiment with the exception of the above-mentioned routines. Therefore, the routines of the camera apparatus according to the third embodiment the same as those of the camera apparatus according to the first embodiment will not be described hereinafter.

From the foregoing description, it will be understood that the camera apparatus according to the third embodiment of the present invention can average, in an appropriate period of time, a luminance deviation “Δ Y” calculated in each field period of time.

The following description will be directed to the operation of the camera apparatus according to the fourth embodiment of the present invention.

When the camera apparatus according to the present invention takes images of extremely high luminance object, the luminance of images tends to be excessively reduced.

When the luminance value “Y” of the R-, G-, and B-images calculated from the sampled R-, G-, and B-image signals corresponding to designated portions of the R-, G-, and B-images exceeds a predetermined maximum luminance level “Y_{H}”, it is preferable to allowing the CPU 21 to reduce the luminance value “Y” of the R-, G-, and B-images to a predetermined maximum luminance level “Y_{H}”, and to prevent the CPU 21 from excessively reducing the luminance value “Y” of the R-, G-, and B-images.

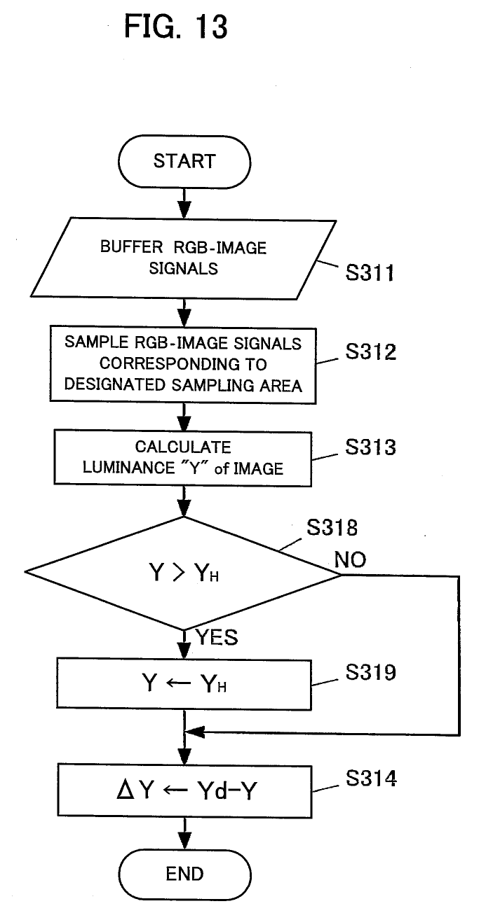

FIG. 13 is a flowchart showing the third luminance deviation calculating routine to be executed by the CPU 21 of the camera apparatus according to the fifth embodiment of the present invention. As shown in FIG. 13, the third luminance deviation calculating routine is substantially the same as the first luminance deviation calculating routine with the exception that the third luminance deviation calculating routine includes a routine to be executed in the steps S318 and S319 defined between the steps 313 and 314.

After the luminance value “Y” of the R-, G-, and B-images is calculated by the CPU 21 from the R-, G-, and B-image signals buffered in the buffer unit 23 (in the step S313), the judgment is made by the CPU 21 (in the step S318) on whether or not the luminance value “Y” of the R-, G-, and B-images exceeds a predetermined maximum luminance level “Y_{H}”.

When the luminance value “Y” of the R-, G-, and B-images exceeds the maximum luminance level “Y_{H}”, the CPU 21 reduces the luminance value “Y” of the R-, G-, and B-images to a predetermined maximum luminance level “Y_{H}” (in the step S319). Then, the CPU 21 calculates, from the maximum luminance level “Y_{H}”, a luminance deviation “Δ Y” from a reference luminance “Yd” to the luminance value “Y” of the R-, G-, and B-images (in the step S314).

When, on the other hand, the luminance value “Y” of the R-, G-, and B-images exceeds the maximum luminance level “Y_{H}”, the CPU 21 calculates, from the luminance value “Y” of the R-, G-, and B-images, a luminance deviation “Δ Y” from a reference luminance “Yd” to the luminance value “Y” of the R-, G-, and B-images.

The routines of the camera apparatus according to the fourth embodiment are the same as those of the camera apparatus according to the first embodiment with the exception of the above-mentioned routines. Therefore, the routines of the camera apparatus according to the fourth embodiment the same as those of the camera apparatus according to the first embodiment will not be described hereinafter.

From the foregoing description, it will be understood that the camera apparatus according to the fourth embodiment of the present invention can allow the CPU 21 to reduce the luminance value “Y” of the R-, G-, and B-images to a predetermined maximum luminance level “Y_{H}”, and to prevent the CPU 21 from excessively reducing the luminance value “Y” of the R-, G-, and B-images when the luminance value “Y” of the R-, G-, and B-images calculated from the sampled R-, G-, and B-image signals corresponding to designated portions of the original images exceeds the maximum luminance level “Y_{H}”.

The following description will be directed to the operation of the camera apparatus according to the fifth embodiment of the present invention.

When the aperture diaphragm 131 is changed in aperture size, when another ND filter 141 is disposed on an optical path, or when the changed gains are set to the R-, G-, and B-preamplifiers 151, the luminance of images is fluctuated. It is, therefore, preferable to reduce the fluctuation of the luminance of images when the R-, G-, and B-images are being taken on the air.

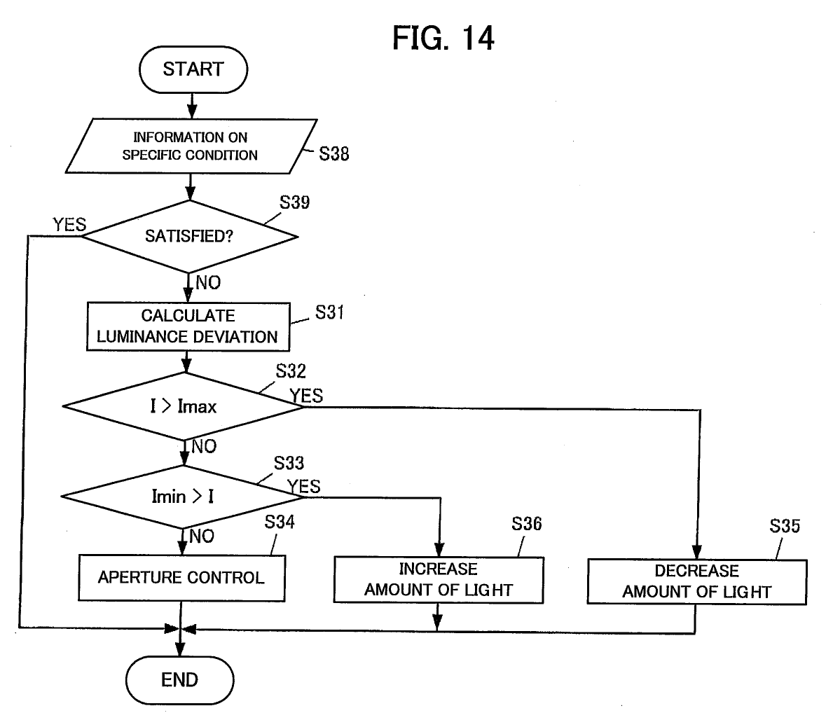

FIG. 14 is a flowchart for explaining the third main routine to be executed by the CPU 21 of the camera apparatus according to the fifth embodiment of the present invention. As shown in FIG. 14, the third main routine is substantially the same as the first main routine with the exception that the third main routine includes a routine executed in the steps 38 and 39 defined before the step S31.

The specific condition information (on whether or not images are being taken on the air) is received by the CPU 21 (in the step S38). The judgment is then made by the CPU 21 (in the step S39) on whether or not images are being taken on the air on the basis of the specific condition information.

When the judgment is made (in the step S39) that specific condition is satisfied, the CPU 21 completes this routine. When, on the other hand, the judgment is made (in the step S39) that the specific conditions are satisfied, the CPU 21 proceeds to the step S31, and continues to execute this routine.

The routines of the camera apparatus according to the fifth embodiment are the same as those of the camera apparatus according to the first embodiment with the exception of the above-mentioned routines. Therefore, the routines of the camera apparatus according to the fifth embodiment the same as those of the camera apparatus according to the first embodiment will not be described hereinafter.

From the foregoing description, it will be understood that the camera apparatus according to the fifth embodiment of the present invention can prevent the luminance of images from being fluctuated under specific condition.

The following description will be directed to the operation of the camera apparatus according to the sixth embodiment of the present invention.

The R-, G-, and B-image signals obtained just after the aperture diaphragm 131 is changed in aperture size, just after the ND filter 141 is switched, or just after the gains are changed by the R-, G-, and B-gain controllers 154, 155, and 156 are unstable in luminance.

It is preferable to stop buffering the R-, G-, and B-image signals when the aperture of the aperture diaphragm 131 is changed in size, when another ND filter 141 is disposed on an optical path, or when the changed gains are set to the R-, G-, and B-preamplifiers 151, 152, and 153, to start to compute an elapsed time, and to restart to buffer the R-, G-, and B-image signals when the judgment is made that the elapsed time exceeds a threshold value.

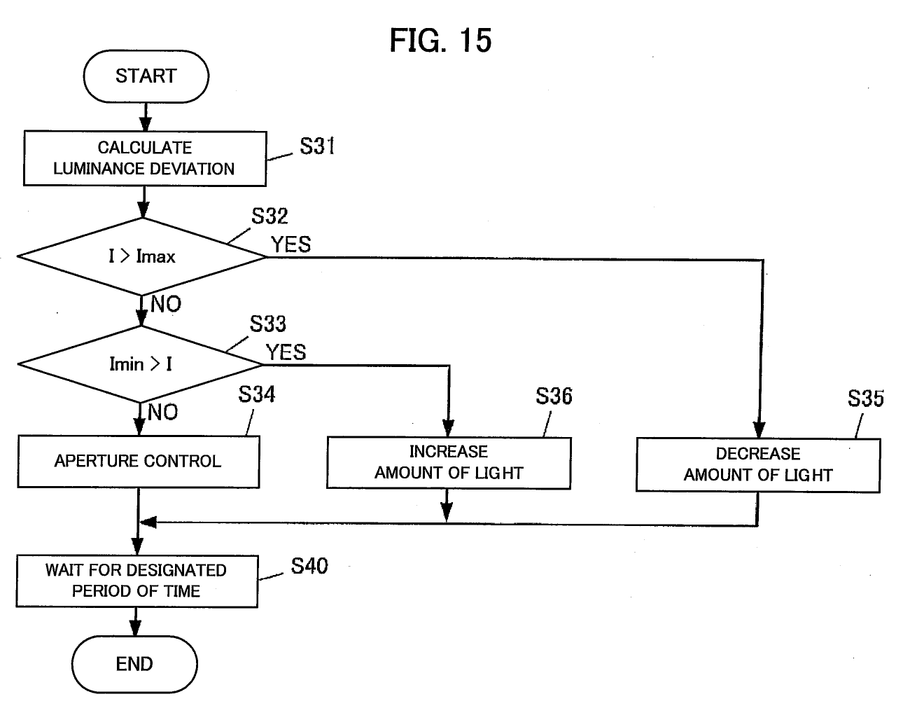

FIG. 15 is a flowchart for explaining the fourth main routine to be executed by the camera apparatus according to the sixth embodiment of the present invention. The fourth main routine is substantially the same as the first main routine with the exception that the fourth main routine further includes a wait routine to be executed in the step S40, defined as a final step of the fourth main routine, when the aperture diaphragm 131 is changed in aperture size, when another ND filter 141 is disposed on an optical path, or when the changed gains are set to the R-, G-, and B-preamplifiers 151, 152, and 153.

When the aperture of the aperture diaphragm 131 is changed in size (in the step S33), when the amount of light is increased (in the step 35), or when the amount of light is reduced (in the step S36), the CPU 21 assumes a waiting mode (in the step S40), and completes the fourth main routine when the judgment is made that the elapsed time exceeds a threshold value.

The routines of the camera apparatus according to the sixth embodiment are the same as those of the camera apparatus according to the first embodiment with the exception of the above-mentioned routines. Therefore, the routines of the camera apparatus according to the sixth embodiment the same as those of the camera apparatus according to the first embodiment will not be described hereinafter.

From the foregoing description, it will be understood that the camera apparatus according to the sixth embodiment of the present invention can prevent the CPU 21 from calculating one or more luminance values from images taken under unstable condition by having the CPU 21 assume a waiting mode just after another ND filter is disposed on an optical path, or just after the gains are changed on the basis of the situation.

In the first to sixth embodiments, each of the R-, G-, and B-gain controllers 154, 155, and 156, each of the R- and B-multipliers 141 and 142, and the image signal outputting means 17 is constituted by an analog circuit. However, each of the R-, G-, and B-gain controllers 154, 155, and 156, each of the R- and B-multipliers 141 and 142, and the image signal outputting means 17 may be constituted by a digital circuit.

In the first to sixth embodiments, the ND filter different in transparency from each other are selectively used on the basis of the situation, and the gains are changed in a stepwise fashion on the basis of the situation. However, the transparency of one ND filter may be gradually changed in a continuous fashion. The gains may be gradually changed in a continuous fashion. The stepwise-change-in-amount-of-light means may be constituted by a shutter operable to maintain its open state over a requested period of time.

Each of the second to sixth embodiments of the camera apparatus has been described as an embodiment modified from the first embodiment of the camera apparatus. It will be obvious to those skilled in the art that various changes may be made without departing from the scope of the invention.

### INDUSTRIAL APPLICABILITY OF THE PRESENT INVENTION

As will be seen from the foregoing description, the camera apparatus according to the present invention has an advantageous effect of keeping its aperture value within a predetermined range while keeping, at a designated level, the luminance of images to be taken over a period of time, and useful as a camera apparatus for automatically controlling, in luminance, images to be taken over a period of time.

What is claimed is:

1. A camera apparatus, comprising:
image providing means for providing images corresponding to three primary colors in light;
converting means for converting said images into R-, G-, and B-image signals;
continuous-change-in-amount-of-light means for attaining continuous change in amount of light to be received by said converting means through said image providing means;
stepwise-change-in-amount-of-light means for attaining stepwise change in amount of light to be received by said converting means through said image providing means;
gain adjusting means for adjusting gains corresponding to said R-, G-, and B-image signals, and regulating said R-, G-, and B-image signals on the basis of said adjusted gains;
luminance controlling means for controlling luminance of image in response to a luminance value calculated from said regulated R-, G-, and B-image signals; and
image signal outputting means for outputting said regulated R-, G-, and B-image signals, wherein
said luminance controlling means includes:
a luminance deviation calculating unit for calculating a luminance deviation between a reference value and said calculated luminance value;
an amount-of-continuous-change judging unit for judging whether an amount of continuous change attained by said continuous-change-in-amount-of-light means is in a predetermined range or not;
a continuous control unit for controlling, on the basis of said luminance deviation, said continuous-change-in-amount-of-light means when said amount of continuous change is in said predetermined range; and
a stepwise control unit for controlling, on the basis of said luminance deviation, either or both of said gain adjusting means and said stepwise-change-in-amount-of-light means when said amount of continuous change is not in said predetermined range.

2. A camera apparatus as set forth in claim 1, in which said amount-of-continuous-change judging unit is adapted to execute a hysteresis routine to enlarge said predetermined range when at least one of said gain adjusting means, said continuous-change-in-amount-of-light means, and said stepwise-change-in-amount-of-light means is activated.

3. A camera apparatus as set forth in claim 1, in which said luminance deviation calculating unit is adapted to calculate an averaged luminance deviation by integrating said luminance deviation over a first period of time.

4. A camera apparatus as set forth in claim 1, which further comprises luminance limitation means for setting, as said luminance value, a predetermined upper limit when said luminance of said image exceeds said upper limit.

5. A camera apparatus as set forth in claim 1, in which said luminance controlling means is adapted to assume a standby mode to stop said control of said luminance of said image when said luminance of said image meets a predetermined requirement.

6. A camera apparatus as set forth in claim 1, in which said luminance controlling means is adapted to restart said control of said luminance of said image after stopping said control of said luminance of said image over a second period of time when said luminance of said image meets a predetermined requirement.
